(19) United States
(12) Patent Application Publication
(10) Pub. No.: US 2024/0375258 A1
(43) Pub. Date: Nov. 14, 2024

(54) Manual Clamp Tool

(71) Applicant: Yao-Tsun Wu, Changhua County (TW)

(72) Inventor: Yao-Tsun Wu, Changhua County (TW)

(21) Appl. No.: 18/313,442

(22) Filed: May 8, 2023

(51) Int. Cl. B25C 5/11; E06B 9/38

(52) U.S. Cl. CPC B25C 5/11; E06B 9/38; B25C 5/0285

(57) ABSTRACT

A manual clamp tool contains a body, a slidable seat, a movable handle, and two clamping arms. The body includes an elongated casing, a fixer, and a drive platform. The elongated casing accommodates multiple retainers which are connected to form a clamper, and the drive platform has a limitation means and a notch. The slidable seat is limited by the limitation means to move linearly within a predetermined range. The movable handle includes a rotatable connection portion and a grip portion. A respective one clamping arm includes an actuation portion and an engaging portion. The actuation portion is connected with the slidable seat so that the movable handle actuates the slidable seat to drive the two clamping arms to push and clamp the multiple retainers on the drive platform forward, and the multiple retainers engage on a rope of a Venetian blind.

### TECHNICAL FIELD

The present invention relates to a manual clamp tool, and more particularly to the manual clamp tool which is applied to fix a rope of a Venetian blind.

### BACKGROUND

Most windows of buildings use curtains as shelter and decoration. There are many types of curtains, and Venetian blinds are a very popular one. A respective one Venetian blind contains an upper support rail, a lower support rail, and multiple ropes connected between the upper support rail and the lower support rail, and multiple slats parallelly arranged among the multiple ropes, such that the multiple slats are movable by changing a changeable length of moving the multiple ropes, thus expanding or retracting the Venetian blinds. Also, the angle of the slats is adjustable by changing the tilted angle of the multiple ropes, thus obtaining air ventilation and sheltering sun.

The conventional ropes are inserted through the upper support rail and the lower support rail and are tied manually. Alternatively, pliers are applied to fix multiple retainers on the multiple ropes of the Venetian blinds manually, thus having labor consumption, slow production efficiency, and high labor cost. In addition, the conventional ropes are tied manually to cause a fixing position error.

To overcome the above-mentioned problem, a pneumatic nail gun is pushed by a high-pressure gas to fix the multiple retainers on the multiple ropes of the Venetian blind. However, an air compressor and an air pipe system has to be matched with the pneumatic nail gun, thus occupying using space and having a large size, heavyweight, and uncomfortable operation of the pneumatic nail gun. Furthermore, it is difficult to carry the pneumatic nail gun.

The present invention has arisen to mitigate and/or obviate the afore-described disadvantages.

### SUMMARY

The primary aspect of the present invention is to provide a manual clamp tool which does not mate with the conventional air compressor or air pipe system, thus reducing using space and a size of the manual clamp tool, obtaining portability and using convenience, and having a lightweight and easy and durable operation.

To obtain the above-mentioned aspects, a manual clamp tool provided by the present invention contains a body, a slidable seat, a movable handle, and two clamping arms.

The body includes an elongated casing, a fixer extending from a front end of the elongated casing, and a drive platform connected with a front end of the fixer. The elongated casing is configured to accommodate multiple retainers which are connected to form a clamper, and the drive platform has a limitation means and a notch communicating with the elongated casing so that the multiple retainers of the clamper are pushed onto the drive platform via the notch.

The slidable seat is disposed on the drive platform and limited by the limitation means to move linearly within a predetermined range.

The movable handle includes a rotatable connection portion formed on a first end of the movable handle, and the movable handle includes a grip portion formed on a second end of the movable handle. The movable handle moves with respective to the manual clamp tool; and

The two clamping arms are rotatably connected by using a shaft. A respective one clamping arm includes an actuation portion formed on a first end thereof, and the respective one clamping arm includes an engaging portion extending from a second end thereof. The actuation portion is connected with the slidable seat, such that the movable handle actuates the slidable seat to drive the two clamping arms to push and clamp the multiple retainers on the drive platform forward, and the multiple retainers engage on a rope of a Venetian blind.

### BRIEF DESCRIPTION OF THE DRAWINGS

FIG. 1 is a perspective view showing the assembly of a manual clamp tool according to a preferred embodiment of the present invention.

FIG. 2 is a perspective view showing the exploded components of the manual clamp tool according to the preferred embodiment of the present invention.

FIG. 3 is a side plan view showing the assembly of the manual clamp tool according to the preferred embodiment of the present invention.

FIG. 4 is a cross sectional view taken along the line A-A of FIG. 3.

FIG. 5 is a cross sectional view taken along the line B-B of FIG. 3.

FIG. 6 is an amplified cross-sectional view of a portion A1 of FIG. 4.

FIG. 7 is a cross sectional view showing the operation of the manual clamp tool according to the preferred embodiment of the present invention.

FIG. 8 is another cross sectional view showing the operation of the manual clamp tool according to the preferred embodiment of the present invention.

FIG. 9 is also another cross sectional view showing the operation of the manual clamp tool according to the preferred embodiment of the present invention.

FIG. 10 is still another cross sectional view showing the operation of the manual clamp tool according to the preferred embodiment of the present invention.

FIG. 11 is an amplified cross sectional view of a portion A2 of FIG. 9.

FIG. 12 is another cross sectional view showing the operation of the manual clamp tool according to the preferred embodiment of the present invention.

FIG. 13 is also another cross sectional view showing the operation of the manual clamp tool according to the preferred embodiment of the present invention.

### DETAILED DESCRIPTION

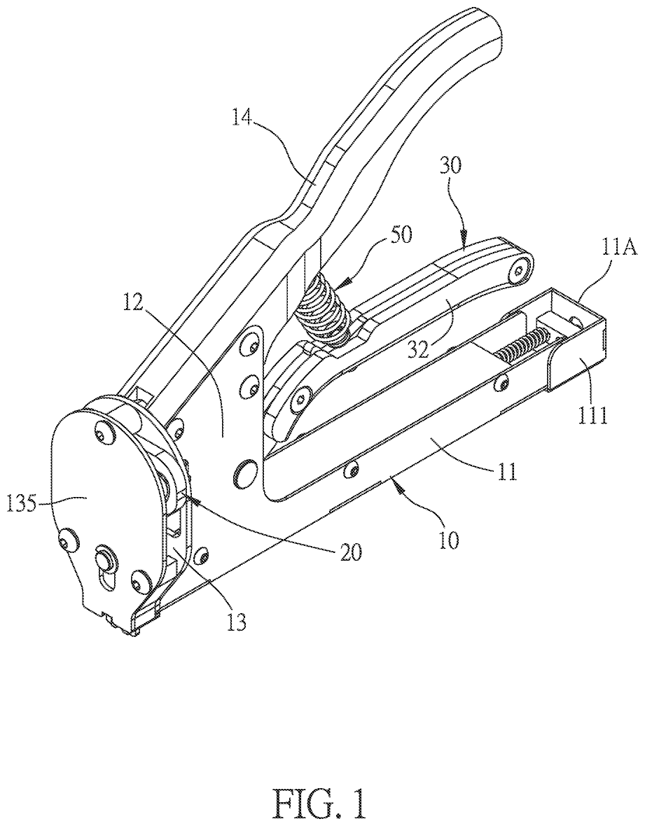

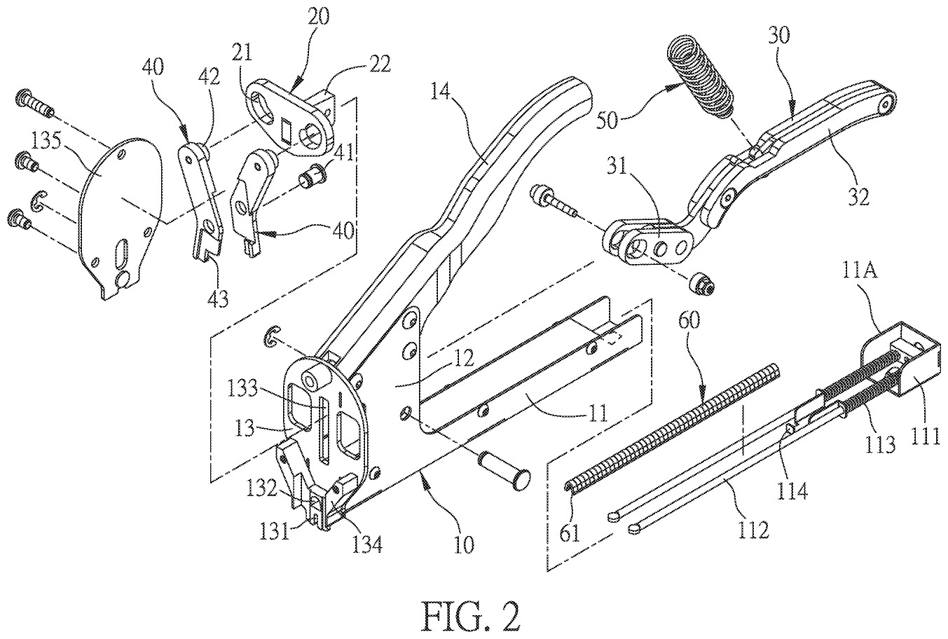

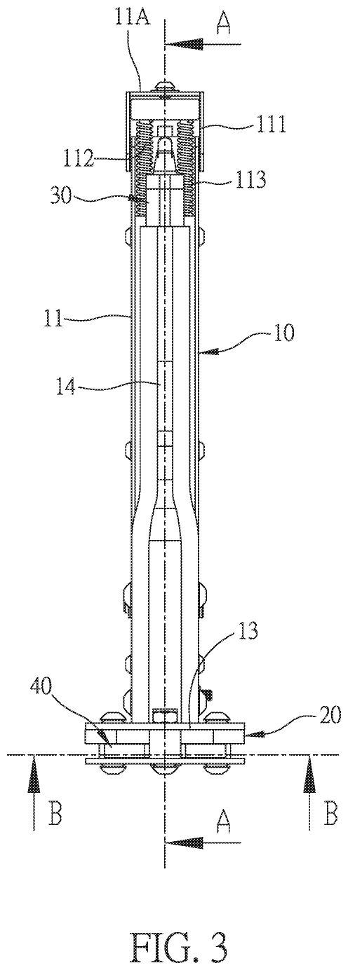

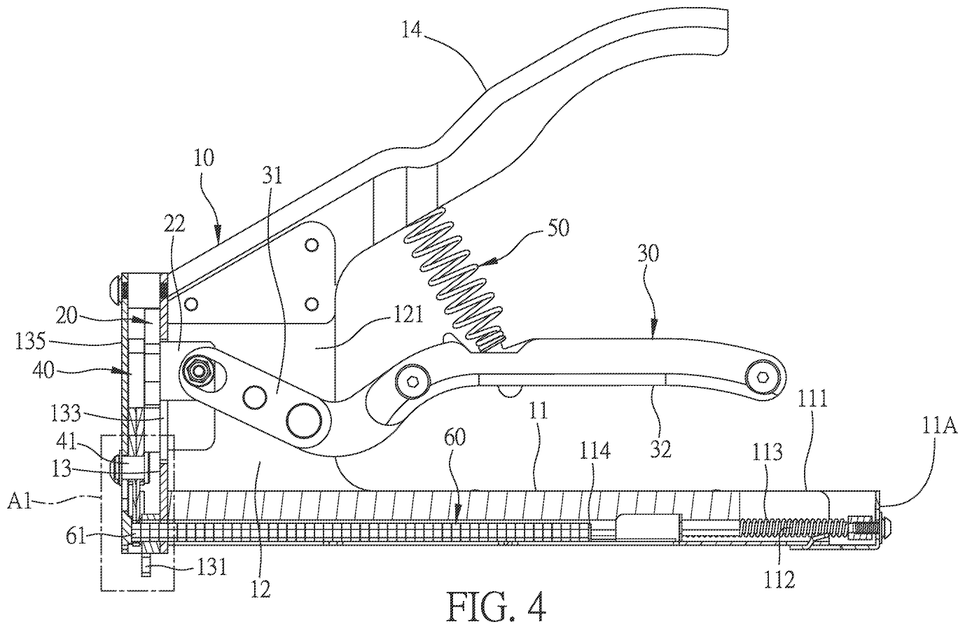

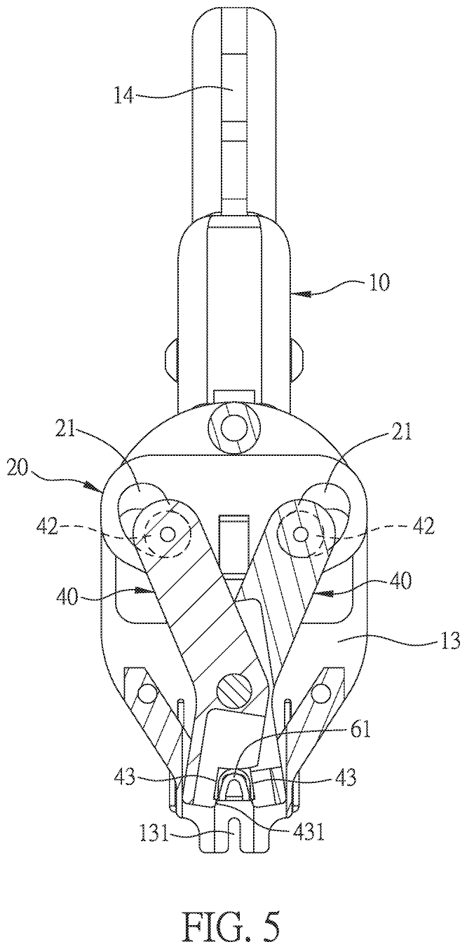

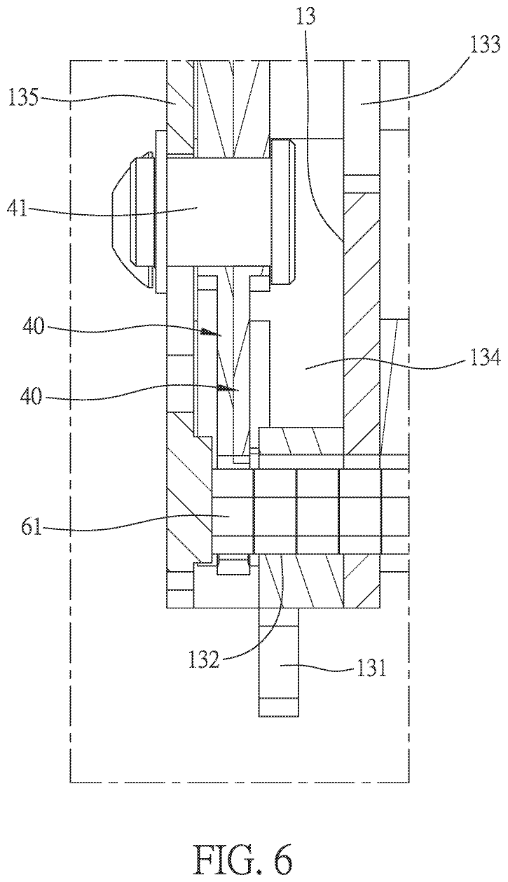

With reference to FIGS. 1-6, a manual clamp tool according to a preferred embodiment of the present invention comprises a body 10, a slidable seat 20, a movable handle 30, two clamping arms 40, and a resilient element 50.

The body 10 includes an elongated casing 11, a fixer 12 extending from a front end of the elongated casing 11, a drive platform 13 connected with a front end of the fixer 12, and a fixed handle 14 connected with a top of the fixer 12, wherein the elongated casing 11 is configured to accommodate multiple retainers 61 which are connected to form a clamper 60 and are in an U shape; wherein the fixer 12 has a coupling groove 121 defined therein, and the drive platform 13 has a limitation means, a receiving slot 131, and a notch 132 communicating with the elongated casing 11 so that the multiple retainers 61 of the clamper 60 are pushed onto the drive platform 13 via the notch 132. In this embodiment, the elongated casing 11 accommodates a push mechanism 11A, and the push mechanism 11A has a fastener 111 configured to engage with an end of the elongated casing 11 away from the fixer 12, wherein the fastener 111 has two sliding rods 112 extending longitudinally therefrom, two springs 113 fitted on the two sliding rods 112 respectively, and a pusher 114, such that the two springs 113 urge the pusher 114 to push the clamper 60 toward the notch 132, wherein the limitation means is a guiding orifice 133 communicating with the coupling groove 121, the drive platform 13 further has a protrusion 134 formed in a V shape, the receiving slot 131 and the notch 132 are defined on the protrusion 134, and a cap 135 is covered on the drive platform 13.

The slidable seat 20 is disposed on the drive platform 13 and is limited by the limitation means to move linearly within a predetermined range, wherein the slidable seat 20 includes two driving orifices 21 symmetrically defined on two sides thereof and being elongated. In this embodiment, the slidable seat 20 includes a slide projection 22 received in the guiding orifice 133 so that the slidable seat 20 slides linearly along the guiding orifice 133.

The movable handle 30 includes a rotatable connection portion 31 formed on a first end thereof, a grip portion 32 formed on a second end of the movable handle 30, wherein the rotatable connection portion 31 is inserted into the coupling groove 121 of the fixer 12, a first end of the rotatable connection portion 31 is rotatably connected with the slide projection 22 of the slidable seat 20 away from the grip portion 32, and a second end of the rotatable connection portion 31 close to the grip portion 32 is rotatably connected with the fixer 12 of the body 10 so that the movable handle 30 moves with respective to the manual clamp tool.

The two clamping arms 40 are rotatably connected by using a shaft 41, and a respective one clamping arm 40 includes an actuation portion 42 formed on a first end thereof and an engaging portion 43 extending from a second end of the respective one clamping arm 40, wherein the actuation portion 42 is a rotatable wheel fitted with a respective one driving orifice 21 of the slidable seat 20, such that the movable handle 30 actuates the slidable seat 20 to drive the respective one clamping arm 40 to move, and the respective one clamping arm 40 clamps or unclamps by sliding the actuation portion 42 in the respective one driving orifice 21, wherein the respective one clamping arm 40 further includes a protruded fringe 431 extending from a front end of the engaging portion 43.

The resilient element 50 is defined between and abuts against the fixed handle 14 and the movable handle 30 so that the movable handle 30 and the fixed handle 14 expand with respective to each other in a normal state. In this embodiment, the resilient element 50 is a spring.

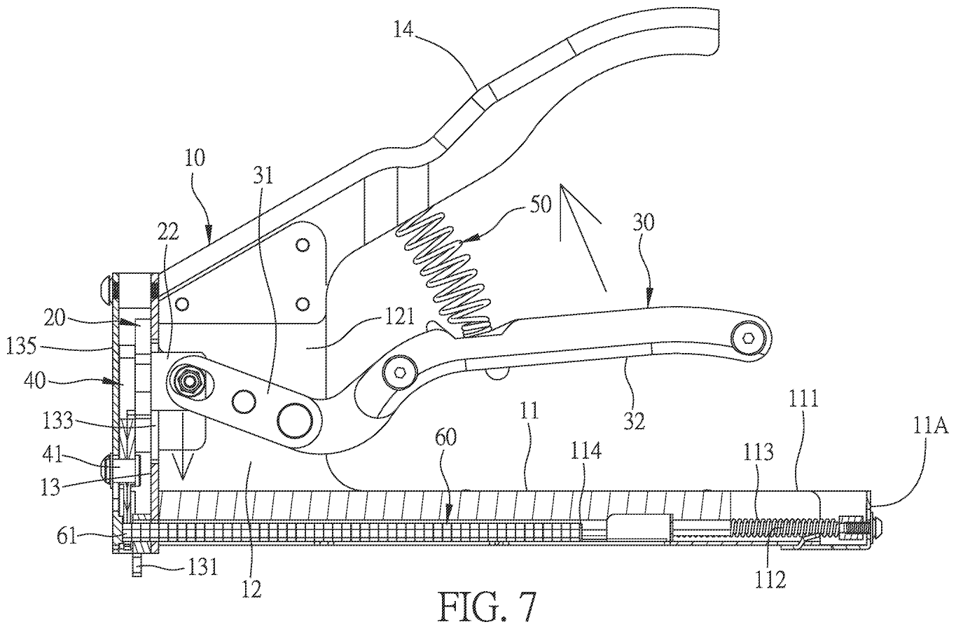

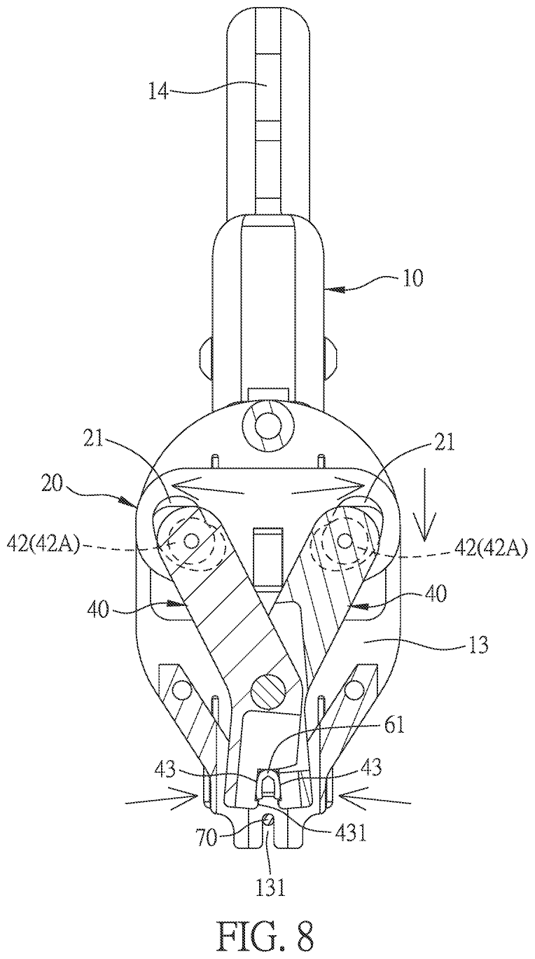

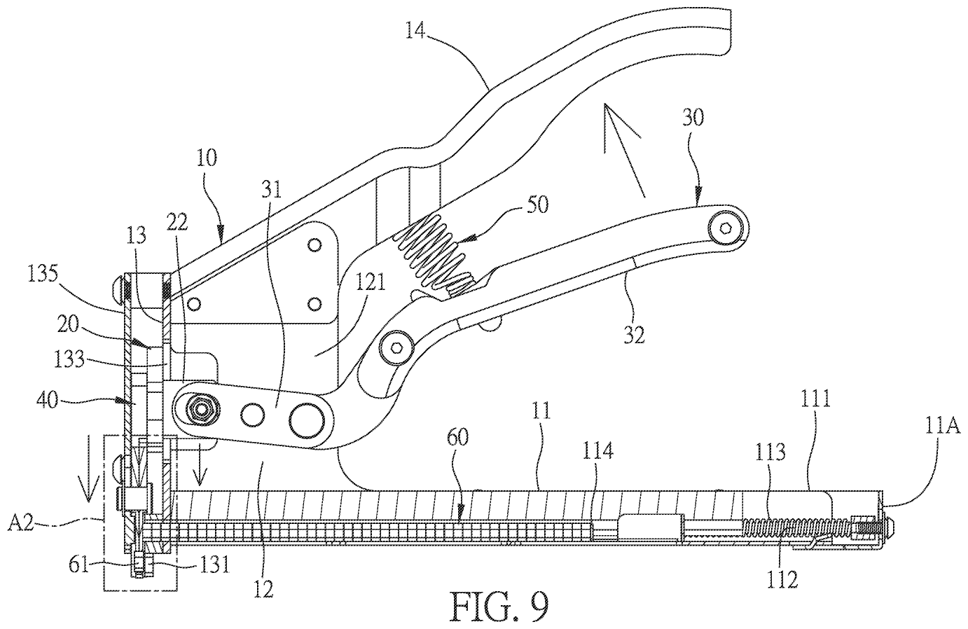

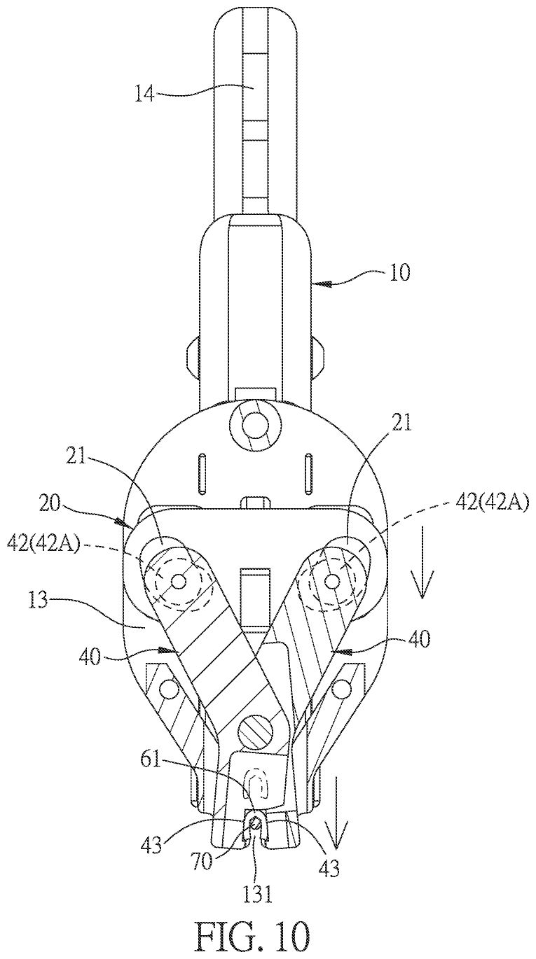

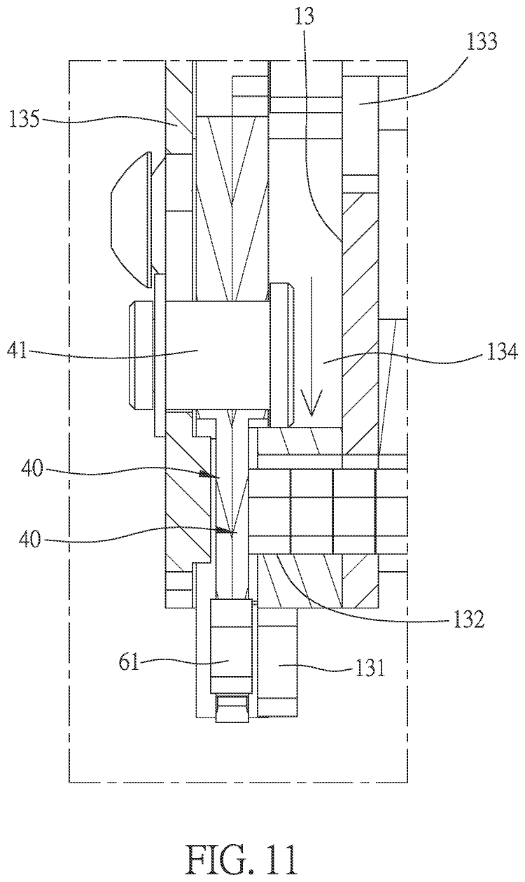

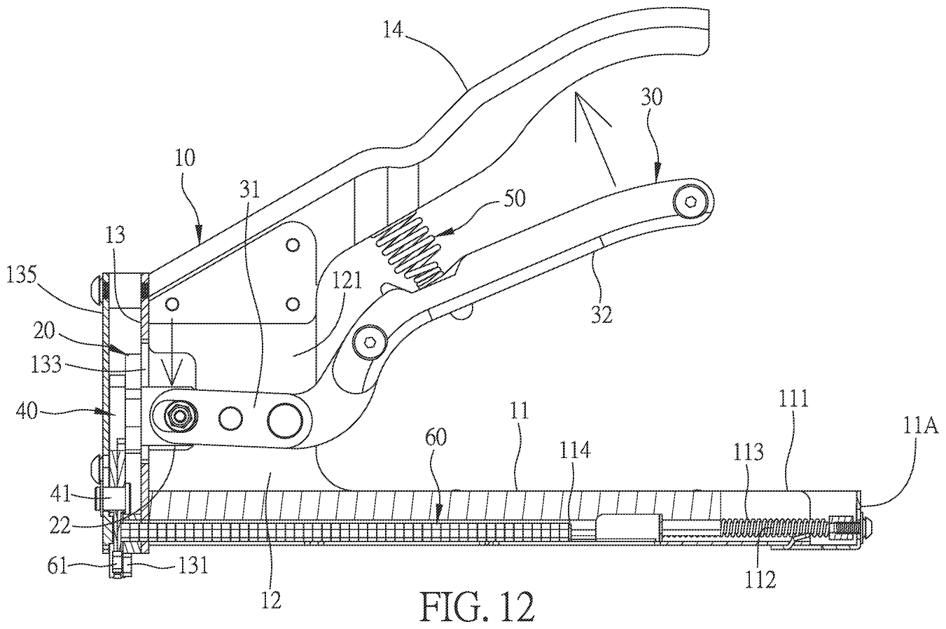

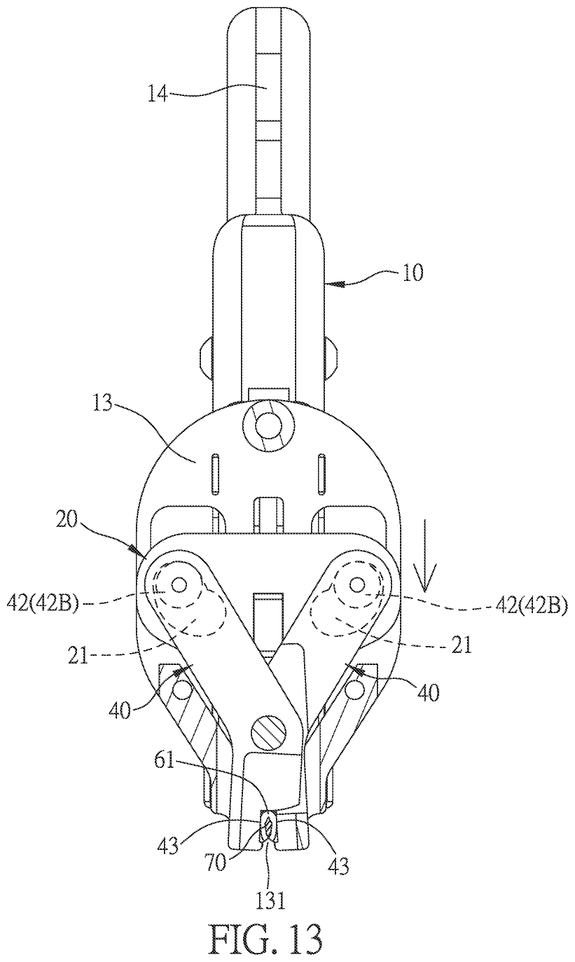

In use, as shown in FIGS. 7 and 8, a rope 70 of a Venetian blind (not shown) is received in the receiving slot 131 of the drive platform 13 of the body 10, the grip portion 32 of the movable handle 30 is pressed to the fixed handle 14 so that the moveable handle 30 actuates the slidable seat 20 to drive the two clamping arms 40 to move forward, and the actuation portion 42 slides to a first position 42A in the respective one driving orifice 21, such that the two engaging portions 43 of the two clamping arms 40 clamp a topmost retainer 61 of the clamp 60, and the two protruded fringes 431 of the two engaging portions 43 engage the topmost retainer 61 securely. Referring further to FIGS. 9-11, the grip portion 32 of the movable handle 30 is continuously pressed to the fixed handle 14 so that the moveable handle 30 actuates the slidable seat 20 to drive the two clamping arms 40 to move forward (in the meantime, the actuation portion 42 stays at the first position 42A still), hence the two clamping arms 40 actuate the topmost retainer 61 to move to the receiving slot 131 of the drive platform 13 of the body 10, thus fitting the rope 70 in the topmost retainer 61. With reference to FIGS. 12 and 13, the grip portion 32 of the movable handle 30 is further pressed to the fixed handle 14 so that the moveable handle 30 actuates the slidable seat 20 to drive the two clamping arms 40 to move forward, and the actuation portion 42 slides to a second position 42B in the respective one driving orifice 21, such that the two engaging portions 43 of the two clamping arms 40 clamps the topmost retainer 61 onto the rope 70.

Thereby, the manual clamp tool of the present invention does not mate with the conventional air compressor or the conventional air pipe system, thus reducing using space and a size of the manual clamp tool, obtaining portable and using convenience, and having lightweight and easy and durable operation.

While the first embodiments of the invention have been set forth for the purpose of disclosure, modifications of the disclosed embodiments of the invention as well as other embodiments thereof may occur to those skilled in the art. The scope of the claims should not be limited by the first embodiments set forth in the examples, but should be given the broadest interpretation consistent with the description as a whole.

What is claimed is:

1. A manual clamp tool comprising:
a body including an elongated casing, a fixer extending from a front end of the elongated casing, and a drive platform connected with a front end of the fixer, wherein the elongated casing is configured to accommodate multiple retainers which are connected to form a clamper, and the drive platform has a limitation means and a notch communicating with the elongated casing so that the multiple retainers of the clamper are pushed onto the drive platform via the notch;
a slidable seat disposed on the drive platform and limited by the limitation means to move linearly within a predetermined range;
a movable handle including a rotatable connection portion formed on a first end of the movable handle, and the movable handle including a grip portion formed on a second end of the movable handle, wherein the movable handle moves with respective to the manual clamp tool; and
two clamping arms being rotatably connected by using a shaft, wherein a respective one clamping arm includes an actuation portion formed on a first end thereof, and the respective one clamping arm includes an engaging portion extending from a second end thereof, wherein the actuation portion is connected with the slidable seat, such that the movable handle actuates the slidable seat to drive the two clamping arms to push and clamp the multiple retainers on the drive platform forward, and the multiple retainers engage on a rope of a Venetian blind.

2. The manual clamp tool as claimed in claim 1, wherein the limitation means is a guiding orifice, the slidable seat includes a slide projection received in the guiding orifice so that the slidable seat slides linearly along the guiding orifice.

3. The manual clamp tool as claimed in claim 1, wherein the fixer has a coupling groove defined therein, and the rotatable connection portion of the movable handle is inserted into the coupling groove of the fixer.

4. The manual clamp tool as claimed in claim 1, wherein the drive platform further has a protrusion formed in a V shape, and the receiving slot and the notch are defined on the protrusion of the drive platform.

5. The manual clamp tool as claimed in claim 1, wherein a cap is covered on the drive platform.

6. The manual clamp tool as claimed in claim 1, wherein the drive platform further has a receiving slot in which the rope of the Venetian blind is received.

7. The manual clamp tool as claimed in claim 1, wherein the elongated casing accommodates a push mechanism, and the push mechanism has a fastener configured to engage with an end of the elongated casing away from the fixer, wherein the fastener has two sliding rods extending longitudinally therefrom, two springs fitted on the two sliding rods respectively, and a pusher, such that the two springs urge the pusher to push the clamper toward the notch.

8. The manual clamp tool as claimed in claim 1, wherein the slidable seat includes two driving orifices symmetrically defined on two sides thereof and being elongated, the actuation portion of the respective one clamping arm is a rotatable wheel fitted with a respective one driving orifice of the slidable seat, such that the slidable seat actuates the respective one clamping arm to move, the respective one clamping arm clamps or unclamps by sliding the actuation portion in the respective one driving orifice, and the respective one clamp arm clamps the multiple retainers and push the multiple retainers outward.

9. The manual clamp tool as claimed in claim 1, wherein the respective one clamping arm further includes a protruded fringe extending from a front end of the engaging portion of the respective one clamping arm.

10. The manual clamp tool as claimed in claim 1, wherein the body further includes a fixed handle connected with a top of the fixer, and a resilient element is defined between and abuts against the fixed handle and the movable handle so that the movable handle and the fixed handle expand with respective to each other in a normal state.

11. The manual clamp tool as claimed in claim 1, wherein a second end of the rotatable connection portion of the movable handle is rotatably connected with the fixer of the body so that the movable handle moves with respective to the manual clamp tool.
